(19) United States
(12) Patent Application Publication
(10) Pub. No.: US 2006/0099912 A1
(43) Pub. Date: May 11, 2006

(54) Apparatus and method for transmit power level reporting with reduced interference

(76) Inventors: Charles P. Binzel, Bristol, WI (US); Cyril Bouvet, Toulouse (FR); Guillaume Favre, Toulouse (FR); Matt C. Hayek, Libertyville, IL (US)

Correspondence Address: MOTOROLA INC, 600 NORTH US HIGHWAY 45, ROOM AS437, LIBERTYVILLE, IL, 60048-5343, US

(21) Appl. No.: 10/974,908

(22) Filed: Oct. 27, 2004

(51) Int. Cl. H04B 17/00

(52) U.S. Cl. 455/67.13; 455/226.1; 455/161.1

(57) ABSTRACT

A method and apparatus for transmit power level reporting with reduced interference. An average radio frequency power level can be computed from measurements for each of a plurality of radio frequency channels of a hop sequence. The presence of interference can be detected on a radio frequency channel. The total average radio frequency power level of the plurality of radio frequency channels can be calculated without the radio frequency power level of the radio frequency channel having the presence of interference. The total average radio frequency power level can be reported to a base station.

### BACKGROUND

1. Field

The present disclosure is directed to a method and apparatus for transmit power level reporting with reduced interference. More particularly, the present disclosure is directed to removing adjacent channel interference when reporting transmit power level measurements.

2. Description of Related Art

Presently, radio frequency channels are being overused and cell sizes are being reduced in wireless communication systems. Accepted reuse patterns and adjacent channel buffers are changing. Unfortunately, with higher density channel reuse, radio frequency channel power measurements being artificially boosted by interference from adjacent cells affects handover algorithms and timing. For example, artificially high traffic channel (TCH) power measurement reporting can lead to delayed handovers and dropped calls. When the interference is at an initial stage, it boosts reported radio frequency power levels. As the interference increases it causes decode errors on the channel and leads to poor call performance.

TCH hopping can help reduce interference. This can provide for overall better signaling performance, but still does not completely address the potential of measurement interference. For example, a boost in the reported level on a TCH of as little as 2 dB can delay a handover long enough to result in a dropped call. There is no accommodation for bad measurements. For example, it has been seen in certain power measurement logs that interference from adjacent channels can influence the measured radio frequency power level by as much as 40 dB.

Thus, there is a need for a method and apparatus for transmit power level reporting with reduced interference.

### SUMMARY

A method and apparatus for transmit power level reporting with reduced interference. An average radio frequency power level can be computed from measurements for each of a plurality of radio frequency channels of a hop sequence. The presence of interference can be detected on a radio frequency channel. The total average radio frequency power level of the plurality of radio frequency channels can be calculated without the radio frequency power level of the radio frequency channel having the presence of interference. The total average radio frequency power level can be reported to a base station.

### BRIEF DESCRIPTION OF THE DRAWINGS

The embodiments of the present disclosure will be described with reference to the following figures, wherein like numerals designate like elements, and wherein:

FIG. 1 is an exemplary block diagram of a system according to one embodiment;

FIG. 2 is an exemplary graph illustrating the power of channels received by a wireless communication device;

FIG. 3 is an exemplary block diagram of a wireless communication device according to one embodiment; and

FIG. 4 is an exemplary flowchart illustrating the operation of the wireless communication device according to one embodiment.

### DETAILED DESCRIPTION

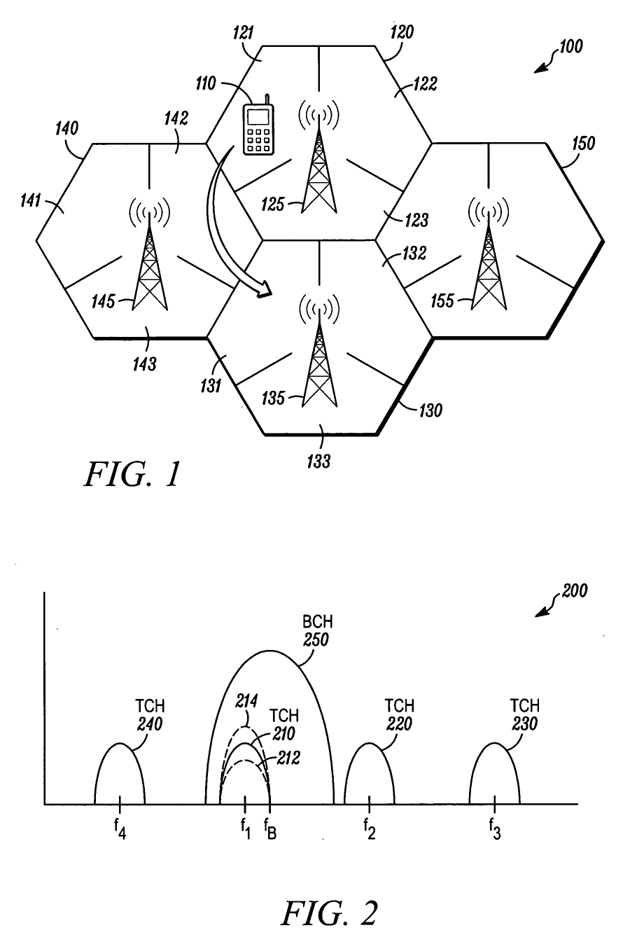

FIG. 1 is an exemplary block diagram of a system 100 according to one embodiment. The system 100 can include a wireless communication device 110 and cells 120, 130, 140, and 150. The cells can be served by respective base stations 125, 135, 145, and 155. Each cell can be divided into sectors served by the same base station. For example, the cell 120 can have sectors 121-123 served by the base station 125, the cell 130 can have the sectors 131-133 served by the base station 135, and the cell 140 can have the sectors 141-143 served by the base station 145. The wireless communication device 110 can be a wireless telephone, a cellular telephone, a personal digital assistant, a pager, a personal computer, a mobile communication device, or any other device that is capable of sending and receiving communication signals on a network including wireless network. The system 100 may include any type of network that is capable of sending and receiving signals, such as wireless signals. For example, the network 110 may include a wireless telecommunications network, a cellular telephone network, a global system for mobile communications network, a time division multiple access network, a code division multiple access network, a satellite communications network, and other like communications systems capable of sending and receiving wireless communication signals.

In operation, the base stations can broadcast cell and system information on a broadcast channel (BCH). The base stations can utilize a traffic channel (TCH) to transfer speech, circuit switched data, or other information between the wireless communication device 110 and the base stations. To avoid interference between sectors and cells, a base station can engage in channel hopping by changing channels or frequencies based on a selected sequence. While it is possible for the system 100 to predict the movement of the wireless communication device 110 between adjacent sectors, such as 121 and 123 or 121 and 143 it is difficult to determine when the wireless communication device 110 has moved between non-adjacent sectors, such as 121 and 131. Yet, the wireless communication device 110 can detect and correct such movement, as discussed below.

FIG. 2 is an exemplary graph 200 illustrating the power of channels received by the wireless communication device 110. The graph 200 illustrates the power 250 measured of a BCH of a new sector, such as sector 131, and the power 210, 220, 230, and 240 measured of the hopped TCH's of an old sector, such as sector 121. As the wireless communication device 110 moves from the old sector 121, to the new sector 131, the measured power 250 of the BCH of the new sector 131 may interfere with the measured power 210 of one of the TCH's of the old sector 121. Thus, while the actual power 212 of the channel may be decreasing from power 210 to power 212, the wireless communication device 110 may measure the same power 210 or ever a higher power 214 due to the interference of the power 250 of the BCH. The wireless communication device 110 can detect this interference and remove affected measurements for reporting a more accurate representation of the level of the TCH on which the wireless communication device 110 is communicating. This can be done by monitoring for conditions that can cause distorted measurement reports and then making appropriate corrections to the reported values. A network of the system 100 can then more accurately monitor the wireless communication device 110's signaling conditions and respond in a more timely manner to avoid dropped calls.

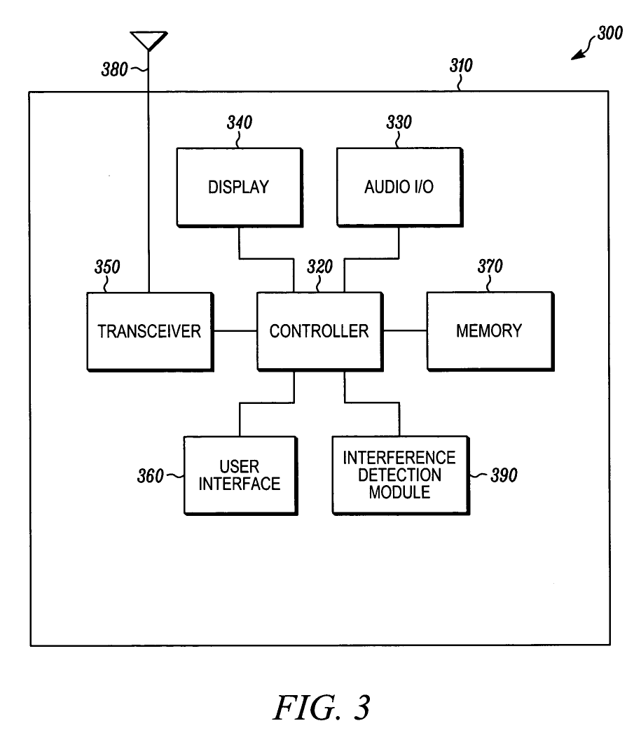

FIG. 3 is an exemplary block diagram of a wireless communication device 300, such as the wireless communication device 110, according to one embodiment. The wireless communication device 300 can include a housing 310, a controller 320 coupled to the housing 310, audio input and output circuitry 330 coupled to the housing 310, a display 340 coupled to the housing 310, a transceiver 350 coupled to the housing 310, a user interface 360 coupled to the housing 310, a memory 370 coupled to the housing 310, and an antenna 380 coupled to the housing 310 and the transceiver 350. The wireless communication device 300 can also include a interference detection module 390. The interference detection module modification module 390 can be coupled to the controller 320, can reside within the controller 320, can reside within the memory 370, can be autonomous modules, can be software, can be hardware, or can be in any other format useful for a module on a wireless communication device 300.

The display 340 can be a liquid crystal display (LCD), a light emitting diode (LED) display, a plasma display, or any other means for displaying information. The transceiver 350 may include a transmitter and/or a receiver. The audio input and output circuitry 330 can include a microphone, a speaker, a transducer, or any other audio input and output circuitry. The user interface 360 can include a keypad, buttons, a touch pad, a joystick, an additional display, or any other device useful for providing an interface between a user and a electronic device. The memory 370 may include a random access memory, a read only memory, an optical memory, a subscriber identity module memory, or any other memory that can be coupled to a mobile communication device.

In operation, the transceiver 350 can send and receive wireless communication signals. The controller 320 can compute an average radio frequency power level from measurements for each of a plurality of radio frequency channels of a hop sequence. The interference detection module 390 can detect the presence of interference on a radio frequency channel. The controller 320 can then calculate a total average radio frequency power level of the plurality of radio frequency channels without the radio frequency power level of the radio frequency channel having the presence of interference. The transceiver 350 can then report the total average radio frequency power level to a base station.

The controller 320 can disregard measurements corresponding to the radio frequency channel having the presence of interference when calculating the total average radio frequency power level. The controller 320 can compute an average radio frequency power level on a plurality of radio frequency channels of a hop sequence by computing an average radio frequency power level on each radio frequency channel of the hop sequence. The interference detection module 390 can detect the presence of interference by detecting a signal level of at least one radio frequency channel of the hop sequence not being accordance with other channels in the hop sequence. The interference detection module 390 can also detect the presence of interference by detecting an abnormal signal to noise ratio on a specific radio frequency channel in the hop sequence. The abnormal signal to noise ratio can be a lower signal to noise ratio on a specific channel than on other channels in the hop sequence. The interference detection module 390 can additionally detect the presence of interference by detecting the presence of a radio frequency channel that is adjacent to a radio frequency channel in the hop sequence. An adjacent channel can be a radio frequency channel that is within 200 kHz of a radio frequency channel in the hop sequence.

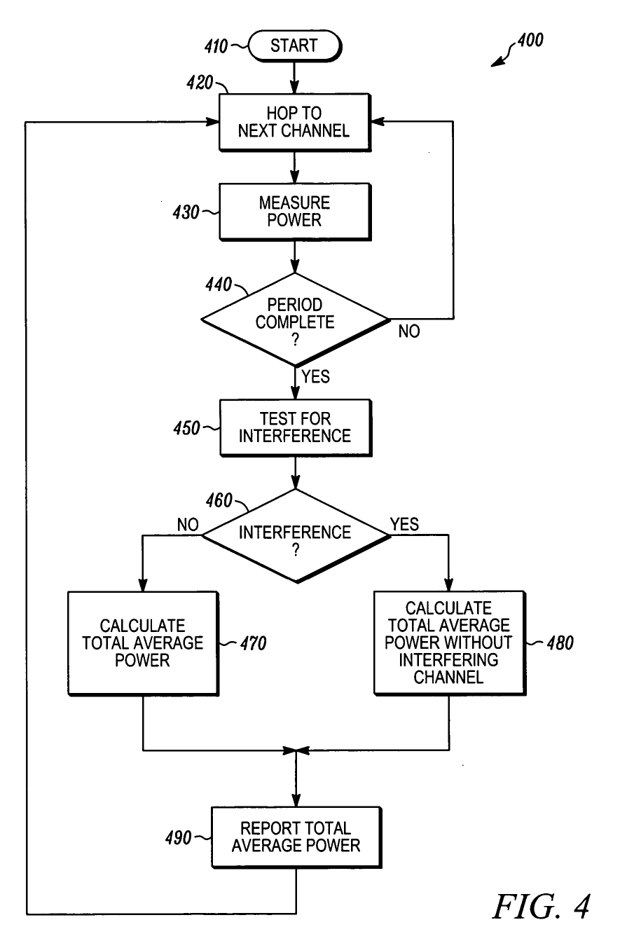

FIG. 4 is an exemplary flowchart 400 illustrating the operation of the wireless communication device 200 according to one embodiment. In step 410, the flowchart begins. In step 420, the wireless communication device 200 can hop to a next channel, such as channel 210, in a hopping sequence. In step 430, the wireless communication device 200 can measure the power level of the current radio frequency channel 210. For each of the radio frequency channels of the hop sequence, an average radio frequency power level can be computed for each channel as accumulated in step 430 or can be computed after the end of a specific measurement period. In step 440, the wireless communication device 200 can determine if a specific measurement period is complete. If not, the wireless communication device 200 can return to step 420. If so, in step 450, the wireless communication device 200 can detect the presence of interference on a radio frequency channel. The wireless communication device 200 can detect the presence of interference by detecting a signal level of at least one radio frequency channel of the hop sequence not being accordance with other channels in the hop sequence. The wireless communication device 200 can also detect the presence of interference by detecting an abnormal signal to noise ratio on a specific radio frequency channel in the hop sequence. An abnormal signal to noise ratio comprises a lower signal to noise ratio on a specific channel than on other channels in the hop sequence. The wireless communication device 200 can additionally detect the presence of interference by detecting the presence of a radio frequency channel that is adjacent to a radio frequency channel in the hop sequence. An adjacent channel can be a radio frequency channel that is within 200 kHz of a radio frequency channel in the hop sequence. If there is no interference detected, in step 470 the wireless communication device 200 can calculate the total average radio frequency power level of all of the plurality of radio frequency channels. If there is interference detected, in step 480 the wireless communication device 200 can calculate the total average radio frequency power level of the plurality of radio frequency channels without the radio frequency channel having the presence of interference. For example, the wireless communication device 200 can disregard measurements corresponding to the radio frequency channel having the presence of interference when calculating the total average radio frequency power level of the plurality of radio frequency channels. In step 490, the wireless communication device 200 can report the total average radio frequency power level to a base station and can return to step 420.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

What is claimed is:

1. A method in a wireless communication device comprising:
computing an average radio frequency power level from measurements for each of a plurality of radio frequency channels of a hop sequence;
detecting a presence of interference on a radio frequency channel;
calculating a total average radio frequency power level of the plurality of radio frequency channels without the radio frequency power level of the radio frequency channel having the presence of interference; and
reporting the total average radio frequency power level to a base station.

2. The method according to claim 1, further comprising disregarding measurements corresponding to the radio frequency channel having the presence of interference when calculating the total average radio frequency power level of the plurality of radio frequency channels.

3. The method according to claim 1, wherein computing an average radio frequency power level on a plurality of radio frequency channels of a hop sequence comprises computing an average radio frequency power level on each radio frequency channel of the hop sequence.

4. The method according to claim 1, wherein detecting the presence of interference comprises detecting a signal level of at least one radio frequency channel of the hop sequence not being accordance with other channels in the hop sequence.

5. The method according to claim 1, wherein detecting the presence of interference comprises detecting an abnormal signal to noise ratio on a specific radio frequency channel in the hop sequence.

6. The method according to claim 5, wherein an abnormal signal to noise ratio comprises a lower signal to noise ratio on a specific channel than on other channels in the hop sequence.

7. The method according to claim 1, wherein detecting the presence of interference comprises detecting the presence of a radio frequency channel that is adjacent to a radio frequency channel in the hop sequence.

8. The method according to claim 7, wherein an adjacent channel comprises a radio frequency channel that is within 200 kHz of a radio frequency channel in the hop sequence.

9. A wireless communication device comprising:
a transceiver configured to send and receive wireless communication signals;
a controller configured to compute an average radio frequency power level from measurements for each of a plurality of radio frequency channels of a hop sequence; and
an interference detection module coupled to the controller, the interference detection module configured to detect a presence of interference on a radio frequency channel,
wherein the controller is further configured to calculate the total average radio frequency power level of the plurality of radio frequency channels without a radio frequency power level of the radio frequency channel having the presence of interference; and
wherein the transceiver is further configured to report the total average radio frequency power level to a base station.

10. The wireless communication device according to claim 9, wherein the controller is further configured to disregard measurements corresponding to the radio frequency channel having the presence of interference when calculating the total average radio frequency power level.

11. The wireless communication device according to claim 9, wherein the controller is further configured to compute an average radio frequency power level on a plurality of radio frequency channels of a hop sequence by computing an average radio frequency power level on each radio frequency channel of the hop sequence.

12. The wireless communication device according to claim 9, wherein the interference detection module is configured to detect the presence of interference by detecting a signal level of at least one radio frequency channel of the hop sequence not being accordance with other channels in the hop sequence

13. The wireless communication device according to claim 9, wherein the interference detection module is configured to detect the presence of interference by detecting an abnormal signal to noise ratio on a specific radio frequency channel in the hop sequence.

14. The wireless communication device according to claim 13, wherein an abnormal signal to noise ratio comprises a lower signal to noise ratio on a specific channel than on other channels in the hop sequence.

15. The wireless communication device according to claim 9, wherein the interference detection module is configured to detect the presence of interference by detecting the presence of a radio frequency channel that is adjacent to a radio frequency channel in the hop sequence.

16. The wireless communication device according to claim 15, wherein an adjacent channel comprises a radio frequency channel that is within 200 kHz of a radio frequency channel in the hop sequence.

17. A method in a wireless communication device comprising:
taking power level measurements on a plurality of radio frequency channels in a hop sequence;
computing an average radio frequency power level, for each of the plurality of radio frequency channels, from the power level measurements;
detecting the presence of interference on a radio frequency channel;
calculating the total average radio frequency power level of the plurality of radio frequency channels without the radio frequency channel having the presence of interference; and
reporting the total average radio frequency power level to a base station.

18. The method according to claim 17, wherein detecting the presence of interference comprises detecting a signal level of at least one radio frequency channel of the hop sequence not being accordance with other channels in the hop sequence

19. The method according to claim 17, wherein detecting the presence of interference comprises detecting an abnormal signal to noise ratio on a specific radio frequency channel in the hop sequence.

20. The method according to claim 17, wherein detecting the presence of interference comprises detecting the presence of a radio frequency channel that is adjacent to a radio frequency channel in the hop sequence.
